(19) United States
(12) Patent Application Publication
(10) Pub. No.: US 2024/0394641 A1
(43) Pub. Date: Nov. 28, 2024

(54) System and method for generating employee performance reviews, goals, development plans and workforce planning, succession planning, career and professional development text and narratives using neural network machine learning models and large language AI models

(71) Applicants: Alex Lowenthal, Portland, OR (US); Christopher Salemme, Berkeley, CA (US); Kevin Dull, Gig Harbor, WA (US)

(72) Inventors: Alex Lowenthal, Portland, OR (US); Christopher Salemme, Berkeley, CA (US); Kevin Dull, Gig Harbor, WA (US)

(21) Appl. No.: 18/202,939

(22) Filed: May 28, 2023

(51) Int. Cl. G06Q 10/0639

(52) U.S. Cl. CPC G06Q 10/06398

(57) ABSTRACT

The present invention relates to a system and method for generating employee performance reviews, goals, development plans, and workforce planning, succession planning, career and professional development text and narratives using neural network machine learning models and large language AI models. The inventive system and method harnesses advanced natural language generation capabilities, data-informed insights, and highly-tailored large language models prompts to automate and enhance the process of generating comprehensive and specific content for various HR functions. This allows organizations to streamline their employee management and planning processes and benefit from personalized and insightful manager-employee communications. The described invention addresses the shortcomings of existing approaches and maximizes the potential benefits of using AI in human resource management for optimizing performance evaluation, assisting in employee retention, and contributing to overall organizational success.

### CROSS-REFERENCE TO RELATED APPLICATION

This application claims priority to U.S. patent application No. 63/346,838 filed on May 28, 2022. These and all other extrinsic materials discussed herein, including publications, patent applications, and patents, are incorporated by reference in their entirety. Where a definition or use of a term in an incorporated reference is inconsistent or contrary to the definition of that term provided herein, the definition of that term provided herein applies and the definition of the term in the reference does not apply.

### PRIOR ART

The present invention relates to systems for automating performance reviews and goal-setting for employees. As such, the prior art includes various systems and methods designed to facilitate employee performance management using both manual and automated processes. However, prior systems have not incorporated artificial intelligence and machine learning to the extent of the present invention.

Several prior art systems and applications focus on rule-based methods or extractive methods for performance review and goal-setting. These often rely on keyword detection, templates, and predetermined rules to generate feedback and performance assessments.

Several prior art references have been identified that relate to automated employee performance reviews. However, none of these references specifically disclose the use of AI language models, such as Generate AI, for creating the content of performance reviews. The following patents represent notable prior art in the field:

1. “Automatic System for Employee Performance Review” (O'Rourke et al., 2014 Jun. 3, U.S. Pat. No. 8,744,904B2)

This patent describes an automatic system for evaluating employee performance. It focuses on generating comprehensive performance reviews by collecting and analyzing various data sources, including feedback and performance metrics. The assignee of this patent is not specified.

2. “Automatic Summarization of Employee Performance” (Harpale et al., 2018 Feb. 8, US20180039927A1)

This patent application presents an automated approach to summarizing employee performance. It aims to streamline the evaluation process by generating concise summaries based on relevant data, such as performance metrics and feedback. The assignee for this patent application is not specified.

3. “System and Method for Evaluating Employee Performance” (Agrawal et al., 2012 Dec. 6, US20120310711A1)

This patent application introduces a system and method for assessing employee performance. It utilizes an algorithm that considers various factors, including goals, competencies, and feedback, to provide a comprehensive evaluation. The assignee of this patent application is not specified.

4. “Method and System for Employee Performance Review” (Wang et al., 2014 Jan. 30, US20140032278A1)

This patent application presents a method and system for conducting employee performance reviews. It incorporates multiple evaluation factors, such as employee self-assessment and supervisor feedback, to generate a comprehensive performance review. The assignee of this patent application is not specified.

5. “AI-Based System for Annual Performance Review” (Singh et al., 2022 May 5, US20220207485A1)

This patent application introduces an AI-based system for conducting annual performance reviews. It utilizes machine learning techniques to analyze employee data and generate comprehensive performance evaluations. The assignee of this patent application is not specified.

6. “Automatic System for Annual Performance Review” (O'Rourke et al., 2014 Jun. 3, U.S. Pat. No. 8,744,904B2)

This patent describes an automatic system for conducting annual performance reviews. It focuses on collecting and analyzing various data sources, including feedback and performance metrics, to generate comprehensive performance evaluations. The assignee of this patent is not specified.

7. “Method and Apparatus for Annual Performance Review” (Sethi et al., 2014 Jun. 12, US20140164073A1)

This patent application presents a method and apparatus for conducting annual performance reviews. It incorporates multiple evaluation factors, such as employee goals, achievements, and feedback, to generate comprehensive performance assessments. The assignee of this patent application is not specified.

8. “System and Method for Annual Performance Review” (Naidu et al., 2011 Dec. 15, US20110307301A1)

This patent application introduces a system and method for conducting annual performance reviews. It focuses on gathering and analyzing employee data, including goals, competencies, and feedback, to generate comprehensive performance evaluations. The assignee of this patent application is not specified.

Note: The assignee information is not specified for the patents mentioned in the provided links.

“Performance Summarization Over Time” (Dandan et al., 2022 Oct. 6, US20220318716A1) This patent application discusses a system and method for summarizing performance over a period of time. The assignee is not specified. The invention focuses on providing a mechanism to summarize an individual's performance over a given time frame, potentially using various data sources and analysis techniques.

“Automatic Summarization of Employee Performance” (Harpale et al., 2018 Feb. 8, US20180039927A1) This patent application describes an automated approach to summarizing employee performance. The assignee is not specified. The invention aims to streamline the process of evaluating employee performance by automatically generating summaries based on relevant data, such as performance metrics and feedback.

“Techniques to Enhance Employee Performance Using Machine Learning” (Pham et al., 2020 Apr. 9, US20200111042A1) This patent application, filed by Capital One Services, LLC, presents techniques for leveraging machine learning to enhance employee performance. The invention proposes using machine learning algorithms to analyze various employee-related data, identify patterns, and provide personalized recommendations to improve performance.

“System and Method for Facilitating a Performance Review Process” (Garman, 2004 Jul. 22, US20040143489A1) This patent application, assigned to Rush-Presbyterian-St. Luke's Medical Center, introduces a system and method for facilitating the performance review process. The invention focuses on providing a structured and automated approach to conducting performance reviews, potentially incorporating feedback from multiple sources and allowing for efficient evaluation and documentation.

In summary, while the prior art references provide various techniques for automating and improving employee performance reviews, including annual performance reviews and the utilization of AI, none of them specifically disclose the use of AI language models like Generative AI for creating the content of the performance reviews. Therefore, the utilization of Generative AI or similar technologies for generating employee performance reviews represents a novel and non-obvious approach in this field.

### BACKGROUND OF THE INVENTION

### 1. Field of the Invention

This invention generally falls under the broad category of Artificial Intelligence (AI) and machine learning technologies designed to support human resources and employee management functions. More explicitly, the innovation involves a system that harnesses advanced natural language generation capabilities, data-informed insights, and the immense language models supplied by cutting-edge machine learning platforms. More specifically, the invention introduces the concept of tailored prompt engineering to create a flexible, customizable, and comprehensive solution for enhancing manager-employee communications.

### 2. Description of Related Art

In today's competitive business environment, effective communication between managers and employees is critical in driving organizational growth, promoting a healthy work culture, and achieving high levels of employee satisfaction and retention. Performance feedback, performance reviews, professional development opportunities, and addressing employee concerns are among the core responsibilities of managers. However, these tasks often prove to be time-consuming, error-prone, and highly subjective, and thus may fail to optimize long-term employee satisfaction and retention. Additionally, conventional approaches for managing employee communications and documenting performance are manual and labor-intensive, ineffectual, and costly.

In the realm of manager-employee communications and performance documentation, traditional solutions have faced challenges and limitations that have hindered their effectiveness. These challenges include fragmentation, limited functionalities, inadequate analytics capabilities, and a lack of customization features to meet the diverse needs of different organizations. However, recent advancements in AI and machine learning technologies have showcased their potential in optimizing various human-resource functions, including talent acquisition, workforce planning, and employee engagement. Notably, the integration of natural language generation and large language models (LLMs) holds significant promise as a future direction in this field.

Accordingly, there is a need for an integrated, modifiable, and advanced AI-enabled platform for manager-employee communication that addresses the shortcomings of the existing approaches and maximizes the potential benefits of using AI in human resource management. Such a platform should facilitate seamless and effective communication between managers and employees to optimize performance evaluation, assist in employee retention, and contribute to overall organizational success.

### SUMMARY OF THE INVENTION

The present invention is a system and method that utilizes neural network machine learning models and large language AI models to generate employee performance reviews, goals, development plans, workforce planning, succession planning, and career and professional development text and narratives. This innovative approach leverages advanced technologies to automate and enhance the process of generating comprehensive and tailored content for various HR functions, empowering organizations to streamline and optimize their employee management and planning processes.

This invention resolves the limitations of existing AI-based platforms for human resources and employee management by offering a comprehensive, next-generation AI-driven solution to empower and streamline manager-employee communications while optimizing the effectiveness of performance reviews, quarterly check-ins, and development opportunities. Utilizing advanced natural language generation, data-driven insights, and highly-tailored machine learning models, this invention provides both turnkey and customizable solutions for automating performance documentation and enhancing communication between managers and employees.

This inventive platform enables managers to efficiently generate well-structured, insightful, and personalized employee communications with minimal effort. It not only improves the overall quality of written communications but also makes them faster and more convenient to create. Furthermore, this invention is adaptable across various industries, enabling organizations to promote employee satisfaction, increase retention rates, lower operating costs, and strengthen the bottom line, thereby fulfilling a long-felt need in the realm of human resource management and employee engagement. The transformative impact of underlying technology sets a new standard and truly signifies a paradigm shift in human resource management and employee communications.

### BRIEF DESCRIPTION OF DRAWINGS

FIG. 1. Overall ReviewBuilder (invention) data flow

FIG. 2. Illustrates the data input and prompt model used by the invention

FIG. 3. Example of short form input template and corresponding summary output

FIG. 4. Example of full review template and corresponding summary output

FIG. 5. Example of prebuilt prompt “tiles”

FIG. 6 Example input input combined with engineered prompt FIG. 7. Sample generative combining user input and output of prompt

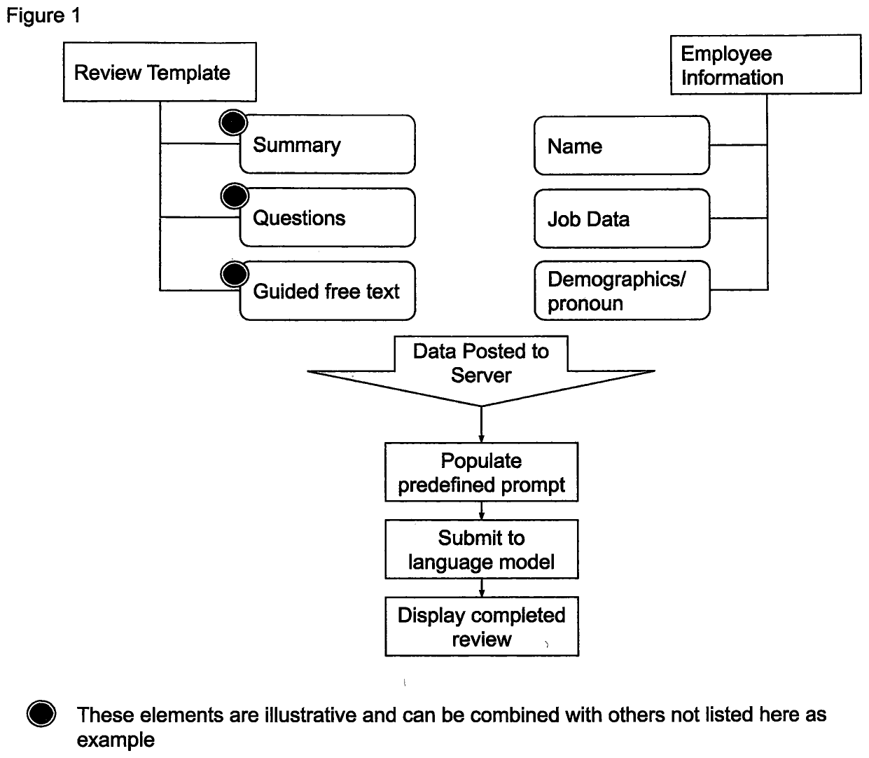

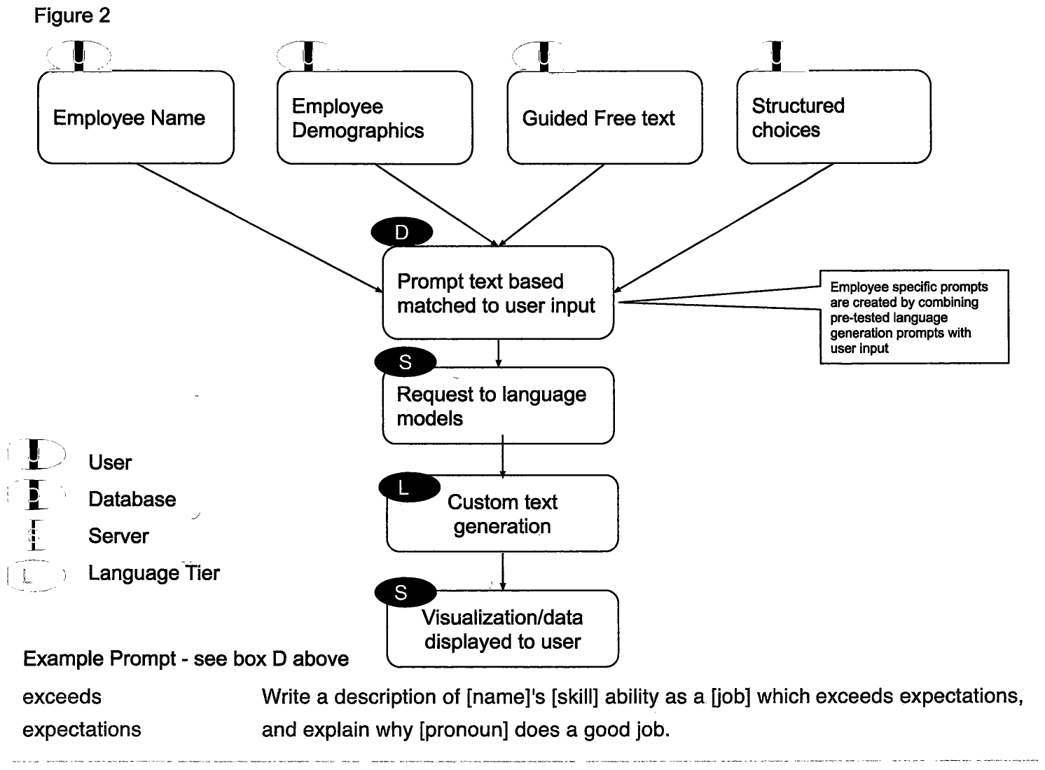

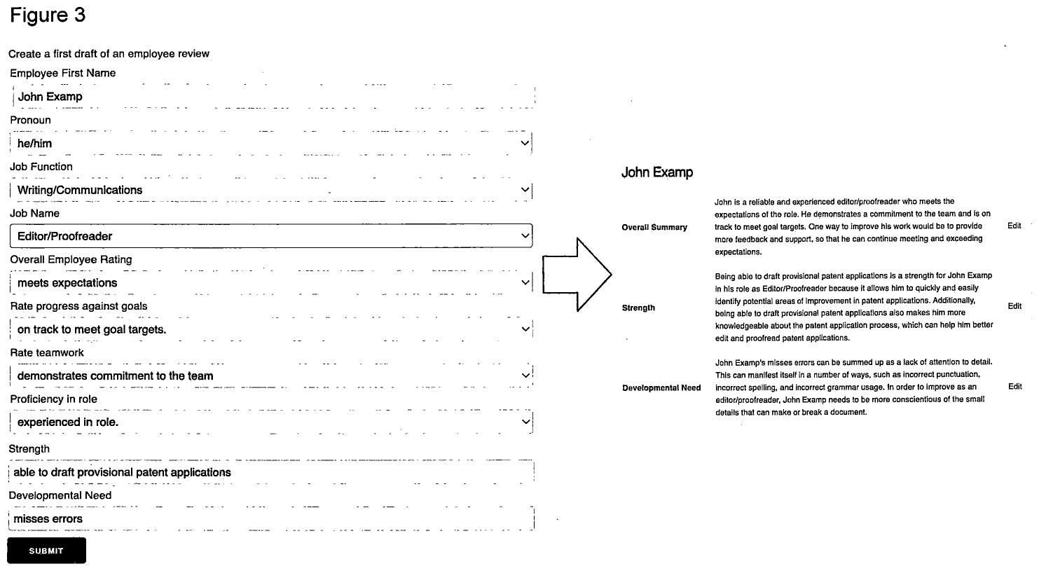

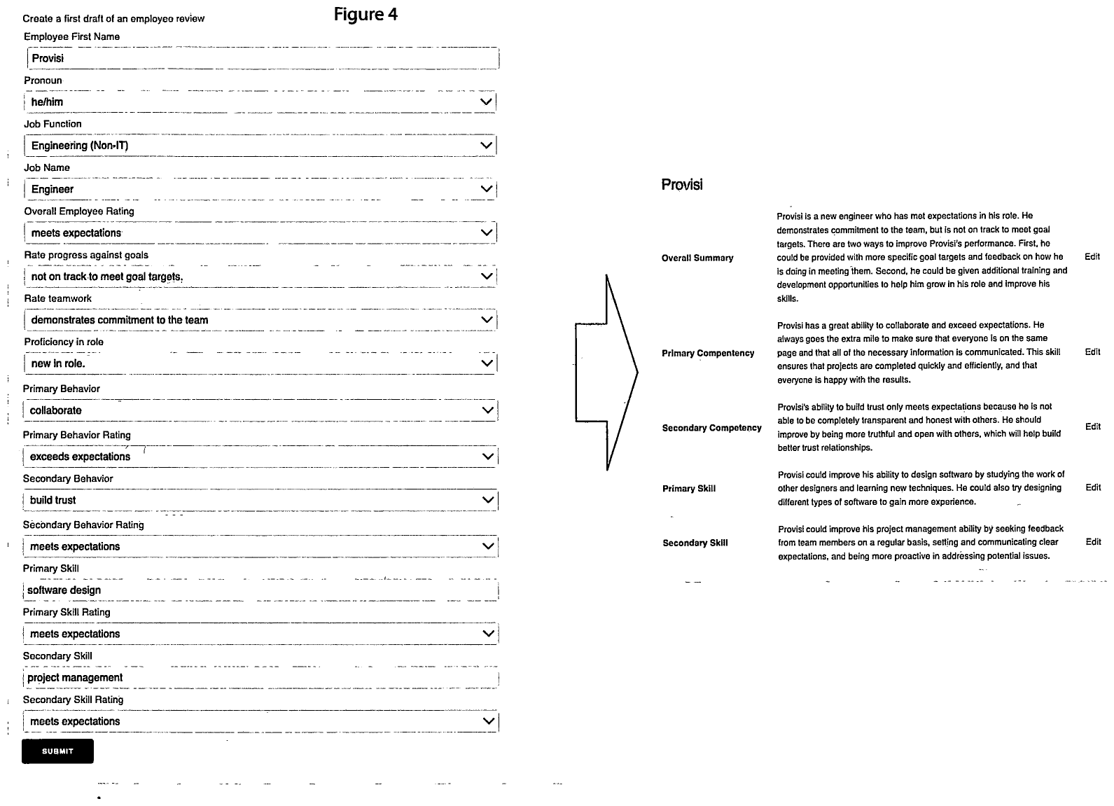

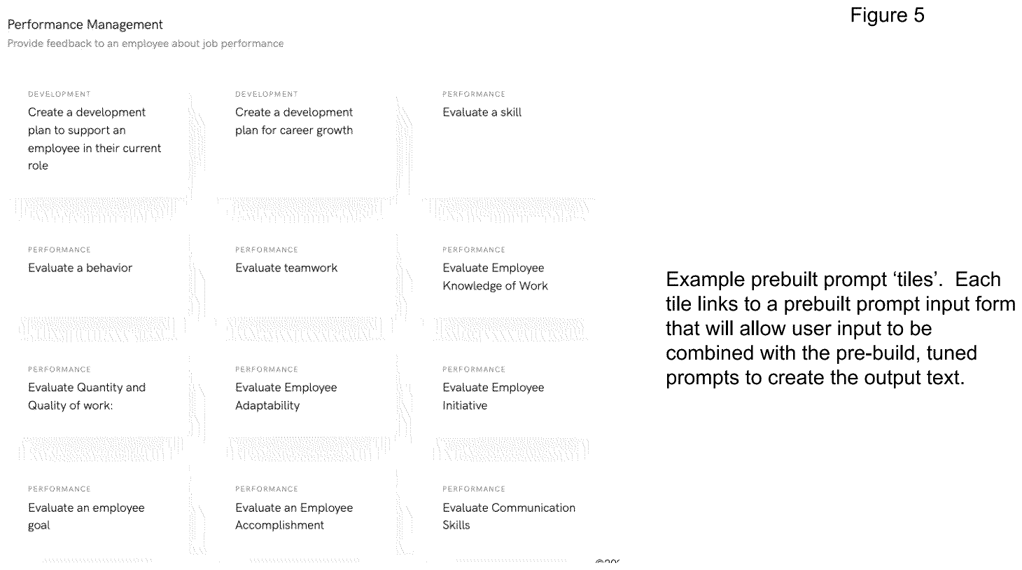

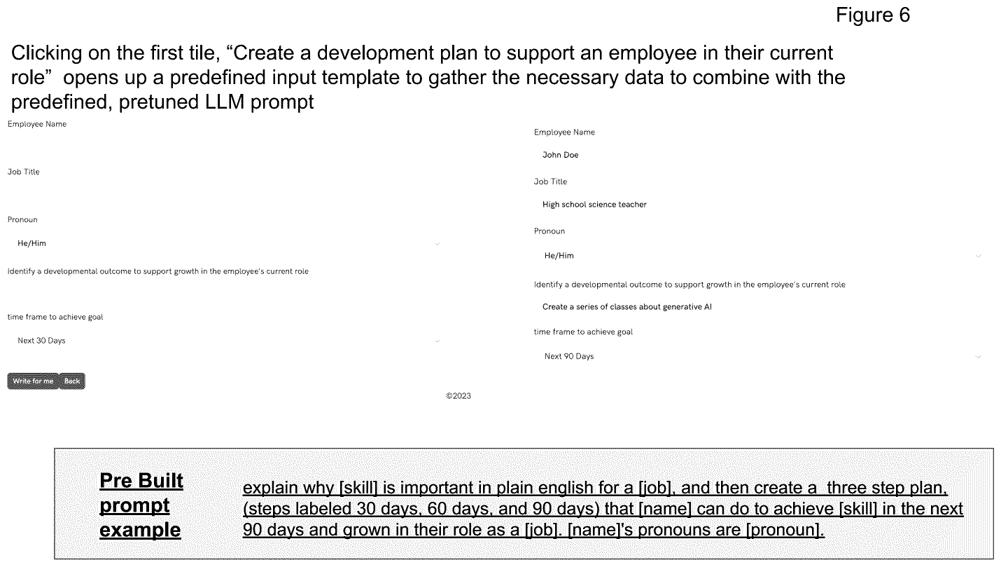

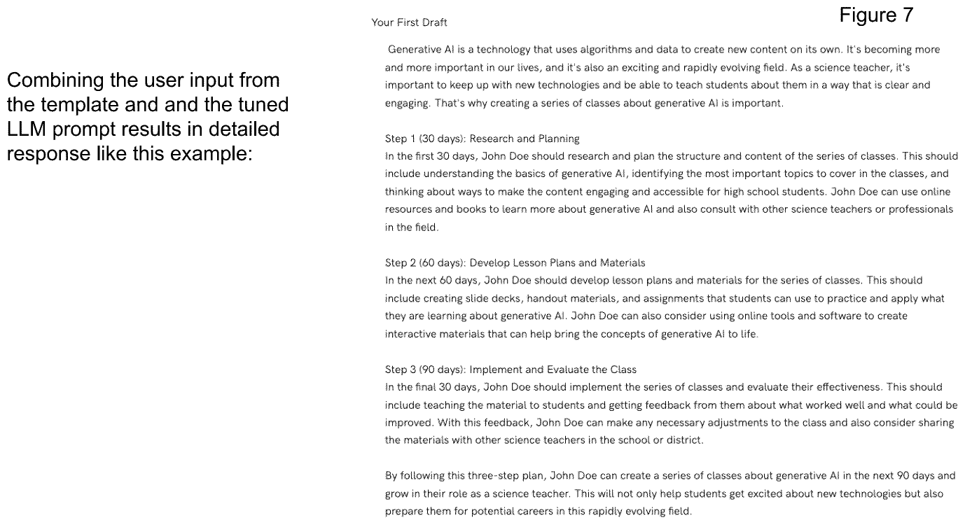

### DETAILED DESCRIPTION OF THE INVENTION

### Detailed Description of the Invention and Preferred Embodiments

The present invention provides a system and method for generating various types of employee performance related documents using machine learning models, particularly generative models, which can effectively automate and streamline the traditional performance review, goals setting, succession planning, and career development processes.

### A. System Overview

The system in the invention includes, but is not limited to, several integral components:

1. Pre-built prompts: These prompts are meticulously designed and tuned to generate appropriate responses from large language models for various performance review related questions, employee demographics, manager ratings, and other collected input. The prompts can be versatile and adaptive, accommodating a variety of scenarios that might be encountered in the realm of performance review and employee development.

2. Pre-built or configurable templates: These templates consist of review questions that are tailored based on an employee's job, position, demographics, performance in role, task-related performance, performance against goals, and other relevant aspects of their job performance. The templates could be customized based on user requirements.

3. Natural Language Processing (NLP) models: The system leverages advanced NLP models capable of generating human-like, comprehensive, and coherent text responses. These models could be fine-tuned with corpora of employee performance reviews, goals, and career development plans.

4. APIs: The system employs Application Programming Interfaces (APIs) to connect with, query, and retrieve responses from neural network machine learning models. The system also makes its responses available via APIs.

5. User interface: This could be a web, desktop, or mobile-based interface, allowing managers and employees to input data into the templates, and users to select review content by category, assign templates to reviewees, complete prompts, and obtain written text from the machine learning model.

### B. Operational Process

The operational process begins with a manager or an employee inputting data into a pre-built template. The template could be general or specific to a position, role, department, or company. The data input may include employee demographics, manager feedback, accomplishments, skills, areas for development, etc.

Once the manager completes the input process, the system utilizes the natural language processing model to generate performance review text, goals, and development opportunities. This generation process combines the manager inputted data with the prebuilt prompts.

The generated text is subsequently outputted as performance review content, which includes but is not limited to, periodic and annual review text, goals, and development plans. The output text can be edited or modified by reviewers, employees or third-party entities. It can also be used as a stand-alone document to be incorporated into an employee's review, goals, succession, and career development plans.

### C. Advanced Features

The system provides capabilities for electronic interfacing with existing HR Performance management systems, which can help populate employee reviews, goals, career development, and succession plans. It also allows transmission of the review text electronically, including through email, text message, chat applications, social media applications, etc.

Moreover, the system offers templates and tools that assist managers in ranking, calibration, tracking, and talent management of their staff, while integrating with primary people management systems supporting learning development, succession planning, and professional development. Employees are also provided with tools for crafting self-assessment documentation, training, or development goals standardized to their jobs or roles.

The system also allows the storage of employee performance review text in a database, which can be used for comparisons with past performance reviews or other reviews in the database. This can provide valuable insights into an employee's growth and performance trajectory over time, aiding in decision-making processes related to promotions, succession planning, and targeted professional development.

In summary, this invention leverages cutting-edge neural network machine learning models to significantly enhance and automate traditionally laborious performance review and employee development processes, thereby saving time, improving accuracy, and enabling more personalized and effective management

1: A system for creating an employee performance report, which includes: pre-designed prompts calibrated to evoke suitable responses from extensive language models based on the review question, rating score, employee demographics, and other collected information; pre-made or customizable templates comprising review questions relevant to the employee's job, position, demographics, role performance, task performance, goal performance, and other relevant aspects of their job performance; integration with natural language processing models capable of text generation; ability to query neural network machine learning models through application programming interfaces; a platform for managers to input data into the pre-set template; a natural language processing model that produces performance review text, objectives, and development opportunities using both the manager-inputted data and pre-set prompts; and a feature that outputs the review text, goals, and opportunities for development.
B) In the system of claim 1, the questions in the pre-set template are chosen from a group including: employee demographics, manager feedback, achievements, skills, company-wide, team, and individual objectives, manager observations, manager-provided anecdotes or examples, areas for development and strength, distinctive qualities affecting employee performance, duration in role, 360-degree feedback, and other relevant data.
C) In the system of claim 1, the natural language processing model is refined using a collection of employee review texts.
D) In the system of claim 1, the outputted performance review text, goals, and development opportunities are organized and displayed in different categories.
E) In the system of claim 1, the categories in which the outputted performance review text, goals, and development opportunities are organized and displayed include summary statements.
F) In the system of claim 1, the system can also accept a request to electronically send the review text and, upon receiving the request, can electronically send the review text in various formats such as print, email, text, pdf, and web or mobile presentation.
G) In the system of claim 1, the system can also accept a request to electronically connect with an existing HR Performance Management system and, upon receiving the request, can electronically integrate with the existing HR Performance Management system.
H) In the method of claim 1, the computer system saves the employee performance review text in a database.
I) In the method of claim 1, the computer system saves the employee performance review text in a database which can be compared with previous performance reviews or other reviews in the database.
J) In the system of claim 1, the system can automatically generate comparative analytics and visualizations based on the performance review text stored in the database.
K) In the system of claim 1, the system incorporates machine learning to improve the quality and relevance of the pre-designed prompts and questions in the template, based on accumulated data over time.
L) In the system of claim 1, the system can be configured to prompt the manager for additional input if the generated performance review text does not meet certain predefined quality or content thresholds.
M) In the system of claim 1, the system is equipped to accept and analyze multi-source feedback, including but not limited to, peer reviews, self-reviews, and customer feedback, to enrich the content of the performance review.
N) In the system of claim 1, the system is further designed to generate recommended action plans and development opportunities tailored to the employee's performance review results and career objectives.
O) In the system of claim 1, the system is designed to store, track, and update the progress of set goals and development opportunities over time, providing periodic reports to both the manager and the employee.
P) In the system of claim 1, the system is capable of integrating with various digital calendars or project management tools to facilitate goal setting, tracking, and reminder notifications for follow-ups on the development opportunities.
